(19) United States
(12) Patent Application Publication
(10) Pub. No.: US 2026/0176424 A1
(43) Pub. Date: Jun. 25, 2026

(54) LIGHT-METAL ALLOY-CONTAINING THERMAL PASTES

(71) Applicant: Wacker Chemie AG, Munich (DE)

(72) Inventor: Sebastian Knör, Munich (DE)

(73) Assignee: Wacker Chemie AG, Munich (DE)

(21) Appl. No.: 18/713,252

(22) PCT Filed: Jan. 28, 2022
(86) PCT No.: PCT/EP2022/052035

§ 371 Date: May 24, 2024

(51) Int. Cl. C08G 77/04; C08G 77/14; C08G 77/18; C08G 77/20; C08G 77/46; C08G 77/50; C08K 5/00; C08L 83/00

(52) U.S. Cl. CPC C08G 77/04; C08G 77/14; C08G 77/18; C08G 77/20; C08G 77/46; C08G 77/50; C08K 5/0025; C08L 83/00

(57) ABSTRACT

Crosslinkable, heat-conducting silicone composition (Y) along with processes for making and uses for the same. The composition (Y) has by volume 5-60% of a crosslinkable silicone composition (S) and 40-95% of at least one thermally conductive filler (Z) having a thermal conductivity of at least 5 W/mK. Where the composition (Y) has a thermal conductivity of at least 0.6 W/mK and at least 20% by volume of metallic light metal alloy particles are present as thermally conductive fillers (Z) having median diameter x50 is in the range of 25-150 μm, that are produced in the last production step by a melting process and have a predominantly rounded surface shape and have a pre-determined distribution range. The metallic light metal alloy particles contain at least 60% by weight of a light metal or of a light semimetal selected from B, C, S, P, Be, Mg, Ca, Al and Si.

The present invention relates to heat-conducting silicone compositions, and to the production and use thereof.

### STATE OF THE ART

Heat-conducting silicone compositions find wide use for heat management in the automobile and electronics industries. Examples of important presentation forms include heat-conducting adhesives, heat-conducting pads, gap fillers and encapsulation compounds. Of the applications mentioned, gap fillers for lithium ion batteries of electrical vehicles are by far the greatest application in terms of volume. Gap fillers are heat-conducting elastomers that completely and sustainably fill air gaps caused by manufacturing tolerances, differences in build height or different coefficients of expansion, and minimize thermal resistance, for example between electronic components and cooling jackets or heatsinks.

The state of the art includes different thermally conductive fillers that are added to the silicone to increase its thermal conductivity. However, these have serious disadvantages. Ceramic fillers, for example alumina, have a very high density and hence increase the weight of the components very significantly. Moreover, they are comparatively costly. Many thermally conductive metallic fillers, for example finely divided copper and silver particles, are likewise unsuitable for gap fillers on account of their high density and cost.

Many further fillers of high thermal conductivity, for example carbon nanotubes, boron nitride and aluminum nitride, on account of their comparatively high costs, can also be used only to a limited degree, or in small amounts or in specific applications.

The prior art includes various heat-conducting silicone compositions containing metal particles as heat-conducting filler. The use of chemically pure metal particles is frequently disadvantageous. Metal particles based, for example, on copper, silver or gold have high thermal conductivity, but significantly increase the weight and costs of the components. Aluminum particles have low density and high thermal conductivity, but on account of their electrical conductivity are unsuitable for many applications, for example in electronics or electromobility. Chemically pure silicon particles are electrically insulating, but are very brittle and have high Mohs hardness, and hence are very abrasive.

The use of alloys enables unification of the advantageous properties of different metals, and production of new compounds having improved properties.

The advantageous properties of metal alloys based on light metals, especially aluminum and silicon, are described, for example, in US2001051673, U.S. Pat. No. 4,292,223, CN109749427, CN109749292.

However, the metal alloy particles according to the prior art are unsuitable for use as gap filler in lithium ion batteries for electrical vehicles:
US2001051673 describes the advantageous properties of alloy particles having an average particle size of 0.5 to 20 μm. The use of such finely divided metal particles is disadvantageous however, since such small particles have comparatively low minimum ignition energy and hence present a risk of dust explosion and entail complex and costly safety precautions in industrial processing. Moreover, gap fillers containing such finely divided alloy particles do not achieve the requisite fire characteristics according to UL94 V-0.

It is also found that gap fillers containing alloy particles having a comparatively narrow particle size distribution do not achieve the requisite fire characteristics according to UL94 V-0.

A disadvantage of ground alloy particles is that such particles have a high surface area and bind a very large amount of polymer. This increases the viscosity of the silicone composition very significantly. It is only possible to produce mixtures having comparatively low filler levels and low thermal conductivity. In the case of higher filler levels, the composition becomes very stiff and can no longer be processed by conventional methods, for example dispensers. It is also found that silicone compositions containing ground alloy particles are comparatively highly combustible.

It was therefore an object of the present invention to provide heat-conducting silicone elastomer compositions that do not show the abovementioned disadvantages of the prior art, and which combine the properties of low density, low costs and high thermal conductivity.

This object is achieved by the inventive crosslinkable heat-conducting silicone compositions (Y) which contain comparatively large light metal alloy particles having an average particle size of 25 to 150 μm, of predominantly rounded surface shape, and which simultaneously have a particularly large or broad particle distribution range. Completely surprisingly, it was found in experiments that these inventive silicone compositions (Y) have distinctly reduced combustibility.

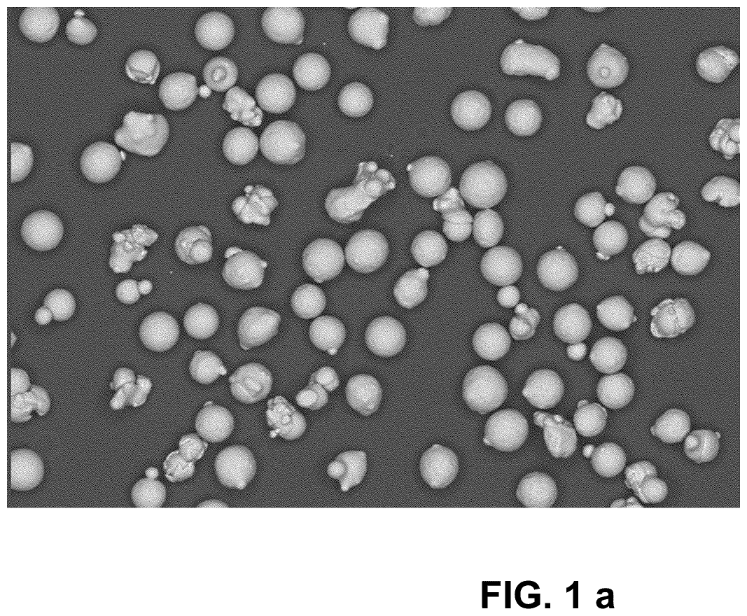

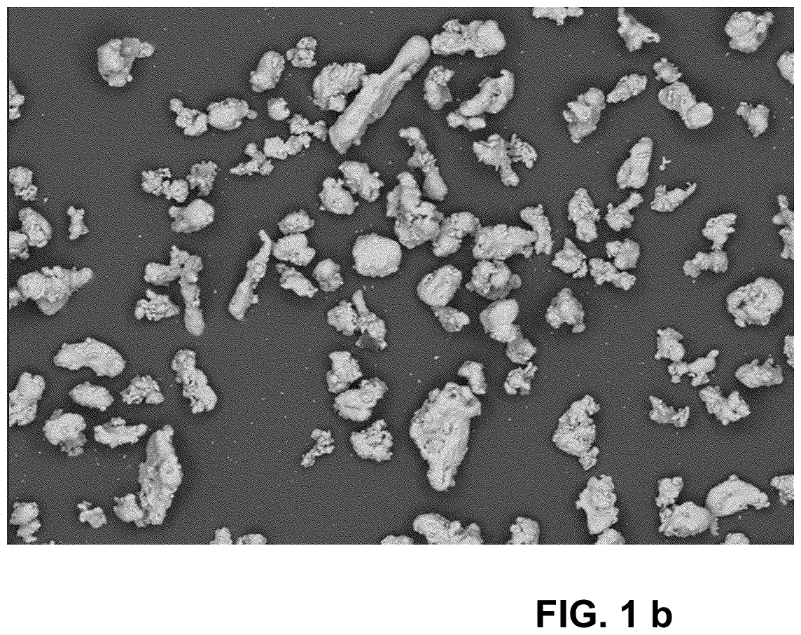

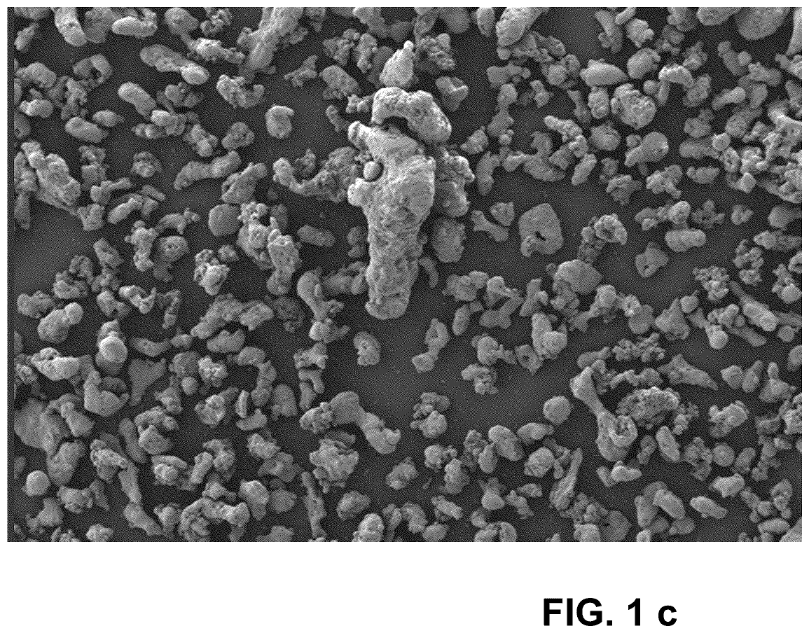

In the context of the present invention, light metal alloy particles having a “predominantly rounded surface shape” are understood to mean those having a spherical to oval, irregular or else nodular shape, with simultaneously smooth and curved surfaces. FIGS. 1 a to 1 c show, by way of example, the inventive predominantly rounded surface shape of these light metal alloy particles. Inventive light metal alloy particles having a predominantly rounded surface shape are produced via a melting process. In other words, the inventive light metal alloy particles must be obtained in the last step of production by solidification from a melt and not by mechanical comminution of the solid material. This can be effected, for example, by plasma rounding or by the atomization of the melt. Atomization is the preferred process here.

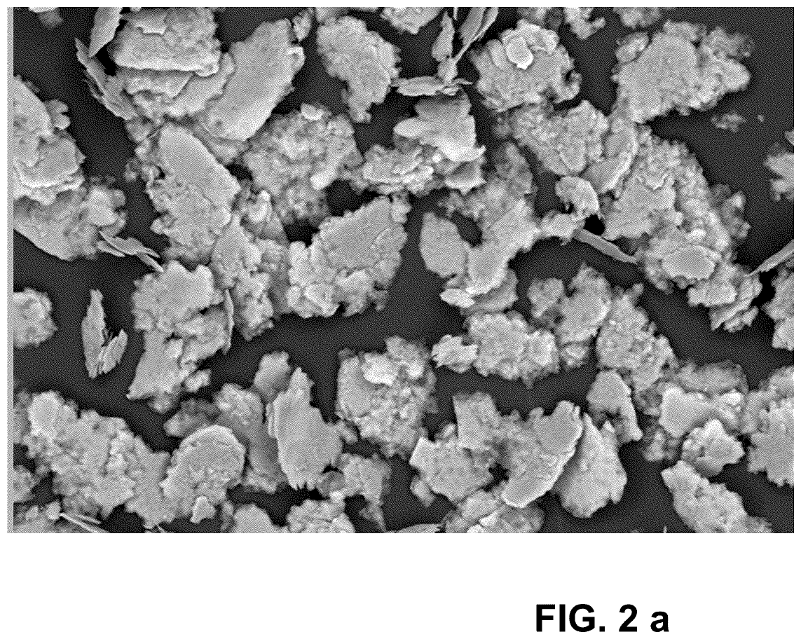

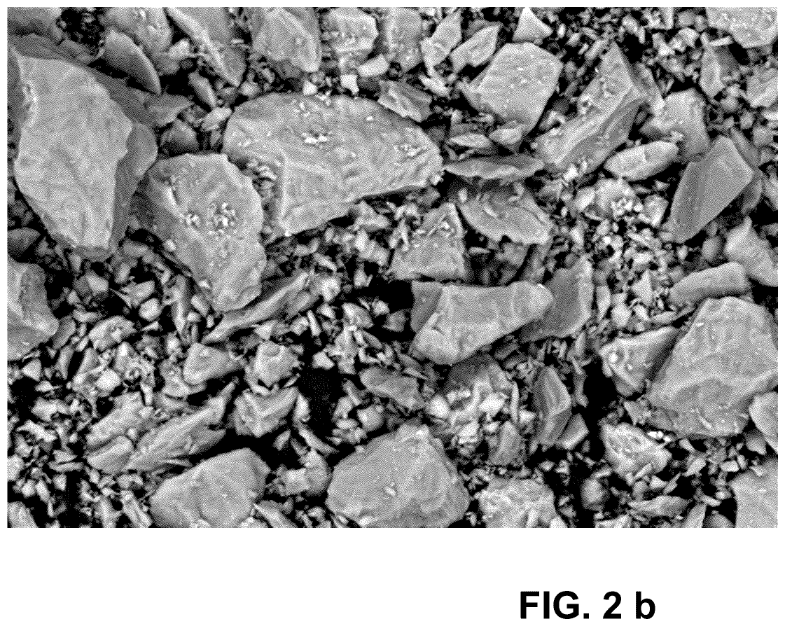

Noninventive light metal alloy particle shapes are shown by way of example by FIGS. 2a and 2b with angular and spiky particle surfaces. These are produced by crushing or grinding or abrasive methods.

Inventive metallic light metal alloy particles are therefore neither angular nor spiky. However, they may contain such particles to the extent of an impurity without any disruption of their inventive action.

The present invention provides a crosslinkable, heat-conducting silicone composition (Y) comprising
5-60% by volume of a crosslinkable silicone composition (S) and
40-95% by volume of at least one thermally conductive filler (Z) having a thermal conductivity of at least 5 W/mK, with the proviso that
the crosslinkable, heat-conducting silicone compositions (Y) has a thermal conductivity of at least 0.6 W/mK, and that
at least 20% by volume of metallic light metal alloy particles present as thermally conductive fillers (Z) fulfill the following features:
   a) their median diameter x50 is in the range of 25-150 μm;
   b) they are produced in the last production step via a melting process and have a predominantly rounded surface shape;
   c) their distribution range SPAN ((x90−x10)/x50) is at least 0.40.

In the context of this invention, the terms “heat-conducting” and “thermally conductive” are equivalent.

Thermally conductive fillers (Z) in the context of this invention are understood to mean any fillers having a thermal conductivity of at least 5 W/mK.

A heat-conducting silicone composition (Y) in the context of this invention is understood to mean those silicone composition that distinctly surpass the thermal conductivity of a filler- and additive-free polydimethylsiloxane, typically about 0.2 W/mK, characterized in that they have a thermal conductivity of at least 0.6 W/mK.

In the context of this invention, all parameters that describe particle size (parameter: median diameter x50), particle size distribution (parameter: standard deviation sigma and distribution range SPAN) are based on a volume-based distribution. The indices mentioned may be determined, for example, by means of dynamic image analysis according to ISO 13322-2 and ISO 9276-6, for example with a Camsizer X2 from Retsch Technology.

In order not to create an excessive number of pages in the description of the present invention, only the preferred embodiments of the individual features are detailed in the text.

However, the expert reader will explicitly understand this manner of disclosure such that any combination of different levels of preference is thus also explicitly disclosed and explicitly desired.

### Crosslinkable Silicone Composition (S)

As crosslinkable silicone composition (S), it is possible to use silicones known to the person skilled in the art from the prior art, such as addition-crosslinking, peroxide-crosslinking, condensation-crosslinking or radiation-crosslinking silicone compositions (S). Preference is given to using addition-crosslinking or peroxide-crosslinking silicone compositions (S).

Peroxide-crosslinking silicone compositions (S) have long been known to the person skilled in the art. In the simplest case, they contain at least one organopolysiloxane having at least 2 crosslinkable groups per molecule, for example methyl or vinyl groups, and at least one suitable organic peroxide catalyst. If the compositions of the invention are crosslinked by means of free radicals, crosslinking agents used are organic peroxides that serve as a source of free radicals. Examples of organic peroxides are acyl peroxides, such as dibenzoyl peroxide, bis(4-chlorobenzoyl) peroxide, bis(2,4-dichlorobenzoyl) peroxide and bis(4-methylbenzoyl) peroxide; alkyl peroxides and aryl peroxides, such as di-tert-butyl peroxide, 2,5-bis(tert-butylperoxy)-2,5-dimethylhexane, dicumyl peroxide and 1,3-bis(tert-butylperoxyisopropyl)benzene; perketals, such as 1,1-bis(tert-butylperoxy)-3,3,5-trimethylcyclohexane; peresters, such as diacetyl peroxydicarbonate, tert-butyl perbenzoate, tert-butyl peroxy-isopropylcarbonate, tert-butyl peroxyisononanoate, dicyclohexyl peroxydicarbonate and 2,5-dimethylhexane 2,5-diperbenzoate.

It is possible to use one kind of organic peroxide; it is also possible to use a mixture of at least two different kinds of organic peroxide.

Particular preference is given to using addition-crosslinking silicone compositions (S).

Addition-crosslinking silicone compositions(S) used in accordance with the invention are known in the prior art and in the simplest case contain
(A) at least one linear compound which have radicals with aliphatic carbon-carbon multiple bonds,
(B) at least one linear organopolysiloxane having Si-bonded hydrogen atoms, or, instead of (A) and (B),
(C) at least one linear organopolysiloxane having SiC-bonded radicals with aliphatic carbon-carbon multiple bonds and Si-bonded hydrogen atoms, and
(D) at least one hydrosilylation catalyst.

The addition-crosslinking silicone compositions (S) may be one-component silicone compositions or else two-component silicone compositions.

In two-component silicone compositions (S), the two components of the addition-crosslinking silicone compositions (S) of the invention may contain any constituents in any combination, generally with the proviso that one component does not simultaneously contain siloxanes having an aliphatic multiple bond, siloxanes with Si-bonded hydrogen and catalyst, i.e. essentially does not simultaneously contain constituents (A), (B) and (D), or (C) and (D).

As is well known, the compounds (A) and (B) or (C) that are used in the addition-crosslinking silicone compositions (S) of the invention are chosen such that crosslinking is possible. For example, compound (A) has at least two aliphatically unsaturated radicals and (B) at least three Si-bonded hydrogen atoms, or compound (A) has at least three aliphatically unsaturated radicals and siloxane (B) at least two Si-bonded hydrogen atoms, or else, rather than compound (A) and (B), siloxane (C) having aliphatically unsaturated radicals and Si-bonded hydrogen atoms in the abovementioned ratios is used. Also are mixtures of (A) and (B) and (C) having the abovementioned ratios of aliphatically unsaturated radicals and Si-bonded hydrogen atoms.

The addition-crosslinking silicone composition (S) of the invention typically contains 30-99.0% by weight, preferably 40-95% by weight and more preferably 50-90% by weight of (A). The addition-crosslinking silicone composition (S) of the invention typically contains 1-70% by weight, preferably 3-50% by weight and more preferably 8-40% by weight (B). If the addition-crosslinking silicone composition of the invention contains component (C), typically at least 30% by weight, preferably at least 45% by weight, more preferably at least 58% by weight (C), based on the total amount of addition-crosslinking silicone composition (S) of the invention is present.

The compound (A) used in accordance with the invention may comprise silicon-free organic compounds having preferably at least two aliphatically unsaturated groups, and organosilicon compounds having at least two aliphatically unsaturated groups, or else mixtures thereof.

Examples of silicon-free organic compounds (A) are 1,3,5-trivinylcyclohexane, 2,3-dimethyl-1,3-butadiene, 7-methyl-3-methylene-1,6-octadiene, 2-methyl-1,3-butadiene, 1,5-hexadiene, 1,7-octadiene, 4,7-methylene-4,7,8,9-tetrahydroindene, methylcyclopentadiene, 5-vinyl-2-norbornene, bicyclo[2.2.1]hepta-2,5-diene, 1,3-diisopropenylbenzene, polybutadiene containing vinyl groups, 1,4-divinylcyclohexane, 1,3,5-triallylbenzene, 1,3,5-trivinylbenzene, 1,2,4-trivinylcyclohexane, 1,3,5-triisopropenylbenzene, 1,4-divinylbenzene, 3-methyl-1,5-heptadiene, 3-phenyl-1,5-hexadiene, 3-vinyl-1,5-hexadiene and 4,5-dimethyl-4,5-diethyl-1,7-octadiene, N,N′-methylenebisacrylamide, 1,1,1-tris(hydroxymethyl)propane triacrylate, 1,1,1-tris(hydroxymethyl)propane trimethacrylate, tripropylene glycol diacrylate, diallyl ether, diallylamine, diallyl carbonate, N,N′-diallylurea, triallylamine, tris(2-methylallyl)amine, 2,4,6-triallyloxy-1,3,5-triazine, triallyl-s-triazine-2,4,6(1H,3H,5H)-trione, diallyl malonate, polyethylene glycol diacrylate, polyethylene glycol dimethacrylate, poly(propylene glycol) methacrylate.

The addition-crosslinking silicone compositions (S) of the invention preferably contain, as constituent (A), at least one aliphatically unsaturated organosilicon compound, it being possible to use any of the aliphatically unsaturated organosilicon compounds used to date in addition-crosslinking compositions, for example silicone block copolymers having urea segments, silicone block copolymers having amide segments and/or imide segments and/or ester amide segments and/or polystyrene segments and/or silarylene segments and/or carborane segments and silicone graft copolymers having ether groups.

Organosilicon compounds (A) used that have SiC-bonded radicals having aliphatic carbon-carbon multiple bonds are preferably linear or branched organopolysiloxanes composed of units of the general formula (I)

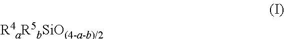

where
   R⁴ are independently the same or different and are an organic or inorganic radical free of aliphatic carbon-carbon multiple bonds,
   R² are independently the same or different and are a monovalent, substituted or unsubstituted, SiC-bonded hydrocarbyl radical having at least one aliphatic carbon-carbon multiple bond,
   a is 0, 1, 2 or 3, and
   b is 0, 1 or 2,
with the proviso that the sum total of a+b is not more than 3 and there are at least 2 R⁵ radicals per molecule.
R⁴ radical may be a mono- or polyvalent radical, where the polyvalent radicals, for example bivalent, trivalent and tetravalent radicals, may then connect multiple, for instance two, three or four, siloxy units of the formula (I) to one another.

Further examples of R⁴ are the monovalent radicals —F, —Cl,
—Br, OR⁶, —CN, —SCN, —NCO and SiC-bonded, substituted or unsubstituted hydrocarbyl radicals, which may be interrupted by oxygen atoms or the —C(O)— group, and divalent radicals Si-bonded at either end as per formula (I). If R⁴ radical comprises SiC-bonded substituted hydrocarbyl radicals, preferred substituents are halogen atoms, phosphorus-containing radicals, cyano radicals, —OR⁶, —NR⁶—, —NR⁶₂, —NR⁶—C(O)—NR⁶₂,
—C(O)—NR⁶₂, —C(O)R⁶, —C(O)OR⁶, —SO₂-Ph and —C₆F₅. R⁶ here is independently the same or different and is a hydrogen atom or a monovalent hydrocarbyl radical having 1 to 20 carbon atoms and Ph is the phenyl radical.

Examples of R⁴ radicals are alkyl radicals, such as the methyl, ethyl, n-propyl, isopropyl, n-butyl, isobulyl, tert-butyl, n-pentyl, isopentyl, neopentyl, tert-pentyl radical, hexyl radicals, such as the n-hexyl radical, heptyl radicals, such as the n-heptyl radical, octyl radicals, such as the n-octyl radical, and isooctyl radicals, such as the 2,2,4-trimethylpentyl radical, nonyl radicals, such as the n-nonyl radical, decyl radicals, such as the n-decyl radical, dodecyl radicals, such as the n-dodecyl radical, and octadecyl radicals, such as the n-octadecyl radical, cycloalkyl radicals, such as cyclopentyl, cyclohexyl, cycloheptyl and methylcyclohexyl radicals, aryl radicals, such as the phenyl, naphthyl, anthryl and phenanthryl radical, alkaryl radicals, such as o-, m-, p-tolyl radicals, xylyl radicals and ethylphenyl radicals, and aralkyl radicals, such as the benzyl radical, the α- and the β-phenylethyl radical.

Examples of substituted R⁴ radicals are haloalkyl radicals, such as the 3,3,3-trifluoro-n-propyl radical, the 2,2,2,2′,2′,2′-hexafluoroisopropyl radical, the heptafluoroisopropyl radical, haloaryl radicals, such as the o-, m- and p-chlorophenyl radical, —(CH₂)—N(R⁶)C(O)NR⁶₂, —(CH₂)ₒ—C(O)NR⁶₂, —(CH₂)ₒ—C(O)R⁶, —(CH₂)ₒ—C(O)OR⁶, —(CH₂)ₒ—C(O)NR⁶₂, —(CH₂)—C(O)—(CH₂)ₚC(O)CH₃, —(CH₂)—O—CO—R⁶, —(CH₂)—NR⁶—(CH₂)ₚ—NR⁶₂, —(CH₂)ₒ—O—(CH₂)ₚCH(OH) CH₂OH, —(CH₂)ₒ(OCH₂CH₂)ₚOR⁶, —(CH₂)ₒ—SO₂-Ph and —(CH₂)ₒ—O—C₆F₅, where R⁶ and Ph conforms to the definition given above and o and p are identical or different integers from 0 to 10.

Examples of R⁴ as divalent radicals Si-bonded at either end as per formula (I) are those that derive from the monovalent examples given above for R⁴ radical in that there is an additional bond through substitution of a hydrogen atom; examples of such radicals are —(CH₂)—, —CH(CH₃)—, —C(CH₃)₂—, —CH(CH₃)—CH₂—, —C₆H₄—, —CH(Ph)-CH₂—, —C(CF₃)₂—, —(CH₂)ₒ—C₆H₄—(CH₂)ₒ—, —(CH₂)ₒ—C₆H₄—C₆H₄—(CH₂)ₒ—, —(CH₂O)ₚ, (CH₂CH₂O)ₒ, —(CH₂)ₒ—Oₓ—C₆H₄—SO₂—C₆H₄—Oₓ—(CH₂)ₒ—, where x is 0 or 1, and Ph, o and p have the definition given above.

R⁴ radical is preferably a monovalent SiC-bonded, optionally substituted hydrocarbyl radical which is free of aliphatic carbon-carbon multiple bonds and has 1 to 18 carbon atoms, more preferably a monovalent SiC-bonded, hydrocarbyl radical which is free of aliphatic carbon-carbon multiple bonds and has 1 to 6 carbon atoms, especially the methyl or phenyl radical.

R⁵ radical may be any groups amenable to an addition reaction (hydrosilylation) with an SiH-functional compound.

If R⁵ radical comprises SiC-bonded, substituted hydrocarbyl radicals, preferred substituents are halogen atoms, cyano radicals and —OR⁶ where R⁶ has the definition given above.

R⁵ radical preferably comprises alkenyl and alkynyl groups having 2 to 16 carbon atoms, such as vinyl, allyl, methallyl, 1-propenyl, 5-hexenyl, ethynyl, butadienyl, hexadienyl, cyclopentenyl, cyclopentadienyl, cyclohexenyl, vinylcyclohexylethyl, divinylcyclohexylethyl, norbornenyl, vinylphenyl and styryl radicals, particular preference being given to using vinyl, allyl and hexenyl radicals.

The molecular weight of constituent (A) may vary within wide limits, for instance between 10² and 10⁶ g/mol. For example, constituent (A) may be an alkenyl-functional oligosiloxane of relatively low molecular weight, such as 1,2-divinyltetramethyldisiloxane, but also a high-polymeric polydimethylsiloxane having Si-bonded vinyl groups in chain or terminal positions, for example having a molecular weight of 10⁵ g/mol (number average determined by means of NMR). Nor is the structure of the molecules that form constituent (A) fixed; more particularly, the structure of a macromolecular, i.e. oligomeric or polymeric, siloxane may be linear, cyclic, branched or else resinous and network-like. Linear and cyclic polysiloxanes are preferably composed of units of the formula R⁴₃SiO_{1/2}, R⁵R⁴₂SiO_{1/2}, R⁵R⁴SiO_{1/2} and R⁴₂SiO_{2/2}, where R⁴ and R⁵ have the definition given above. Branched and network-like polysiloxanes additionally contain trifunctional and/or tetrafunctional units, preference being given to those of the formulae R⁴SiO_{3/2}, R⁵SiO_{3/2} and SiO_{4/2}. It is of course also possible to use mixtures of different siloxanes that meet the criteria of constituent (A).

Particularly preferred as component (A) is the use of vinyl-functional, essentially linear polydiorganosiloxanes having a viscosity of 10 to 100 000 mPa·s, more preferably of 15 to 20 000 mPa·s, especially preferably 20 to 2000 mPa·s, in each case at 25° C.

As organosilicon compound (B), it is possible to use any hydrogen-functional organosilicon compounds that have also been used to date in addition-crosslinkable compositions.

Organopolysiloxanes (B) having Si-bonded atoms that are used are preferably linear, cyclic or branched organopolysiloxanes composed of units of the general formula (III)

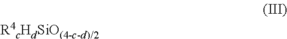

where
   R⁴ has the definition given above,
   c is 0.12 or 3 and
   d is 0, 1 or 2,
with the proviso that the sum total of c+d is not more than 3 and there are at least two Si-bonded hydrogen atoms per molecule. There is preferably at least one organopolysiloxane (B) having at least three, more preferably at least four, Si-bonded hydrogen atoms per molecule.

The organopolysiloxane (B) used in accordance with the invention preferably contains Si-bonded hydrogen in the range from 0.01 to 1.7 percent by weight (% by weight), based on the total weight of the organopolysiloxane (B). Preferably in the range of 0.02-0.8% by weight, more preferably in the range of 0.03-0.3% by weight.

The molecular weight of constituent (B) may likewise vary within wide limits, for instance between 10² and 10⁶ g/mol. For example, constituent (B) may be an SiH-functional oligosiloxane of relatively low molecular weight, such as tetramethyldisiloxane, but also a high-polymeric polydimethylsiloxane having SiH groups in chain or terminal positions or a silicone resin having SiH groups.

Nor is the structure of the molecules that form constituent (B) fixed; more particularly, the structure of a macromolecular, i.e. oligomeric or polymeric, SiH-containing siloxane may be linear, cyclic, branched or else resinous and network-like. Linear and cyclic polysiloxanes (B) are preferably composed of units of the formula R⁴₃SiO_{1/2}, HR⁴₂SiO_{1/2}, HR⁴SiO_{2/2} and R⁴₂SiO_{2/2}, where R⁴ has the definition given above. Branched and network-like polysiloxanes additionally contain trifunctional and/or tetrafunctional units, preference being given to those of the formulae R⁴SiO_{3/2}, HSiO_{3/2} and SiO_{4/2}, where R⁴ has the definition given above.

It is of course also possible to use mixtures of different siloxanes that meet the criteria of constituent (B). Particular preference is given to the use of low molecular weight SiH-functional compounds such as tetrakis(dimethylsiloxy)silane and tetramethylcyclotetrasiloxane, and also of SiH-containing siloxanes of higher molecular weight, such as poly(hydro-methyl)siloxane and poly(dimethylhydromethyl)siloxane, or analogous SiH-containing compounds in which some of the methyl groups have been replaced by 3,3,3-trifluoropropyl or phenyl groups.

Particularly preferred, as constituent (B), is the use of SiH-containing, essentially linear poly(hydromethyl)siloxanes and poly(dimethylhydromethyl)siloxanes, which may also be hydrodimethylsiloxy-terminated, having a viscosity in the range from 1 to 100 000 mPa·s, preferably in the range of 2 to 1000 mPa·s, more preferably in the range of 3 to 750 mPa·s, especially preferably in the range of 5 to 500 mPa·s, in each case at 25° C., and the use of hydrodimethylsiloxy-terminated polydimethylsiloxanes having a viscosity of 10 to 100 000 mPa·s, more preferably of 15 to 20 000 mPa·s, especially preferably 20 to 2000 mPa·s, in each case at 25° C., and mixtures thereof.

Constituent (B) is preferably present in the crosslinkable silicone compositions (S) of the invention in such an amount that the molar ratio of SiH groups to aliphatically unsaturated groups from (A) is 0.1 to 10, more preferably between 0.5 and 5.0, especially between 0.5 and 3.

Components (A) and (B) used in accordance with the invention are commercial products or preparable by standard chemical processes.

Rather than components (A) and (B), the silicone compositions (S) of the invention may contain organopolysiloxanes (C) simultaneously containing aliphatic carbon-carbon multiple bonds and Si-bonded hydrogen atoms. It is also possible for the silicone compositions (S) of the invention to contain all three components (A), (B) and (C).

If siloxanes (C) are used, these are preferably those composed of units of general formulae (IV), (V) and (VI)

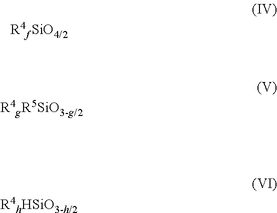

where
   R⁴ and R⁵ have the definition given above,
   f is 0, 1, 2 or 3,
   g is 0, 1 or 2 and
   his 0, 1 or 2,
with the proviso that there are at least 2 R⁵ radicals and at least 2 Si-bonded hydrogen atoms per molecule.

Examples of organopolysiloxanes (C) are those composed of SO_{4/2}, R⁴₃SiO_{1/2}, R⁴₂R⁵SiO_{1/2} and R⁴₂HSiO_{1/2} units, called MP resins, where these resins may additionally contain R⁴SiO_{3/2} and R⁴₂SiO units, and linear organopolysiloxanes consisting essentially of R⁴₂R⁵SiO_{1/2}, R⁴₂SiO and R⁴HSiO units with R⁴ and R⁵ as defined above.

The organopolysiloxanes (C) preferably have an average viscosity of 0.01 to 500 000 Pa·s, more preferably 0.1 to 100 000 Pa·s, in each case at 25° C. Organopolysiloxanes (C) are preparable by standard chemical methods.

As hydrosilylation catalyst (D), it is possible to use any of the heat- or UV-curing catalysts known from the prior art. Component (D) may be a platinum group metal, for example platinum, rhodium, ruthenium, palladium, osmium or iridium, an organometallic compound or a combination thereof. Examples of component (D) are compounds such as hexachloroplatinum(IV) acid, platinum dichloride, platinum acetylacetonate and complexes of said compounds encapsulated in a matrix or a core/shell-type structure. The platinum complexes having low molecular weight of the organopolysiloxanes include 1,3-diethenyl-1,1,3,3-tetramethyldisiloxane complexes with platinum. Further examples are platinum-phosphite complexes or platinum-phosphine complexes. For light- or UV-curing compositions, it is possible, for example, to use alkyl-platinum complexes such as derivatives of cyclopentadienyltrimethylplatinum(IV), cyclooctadienyldimethylplatinum(II) or diketonato complexes, for example bisacetylacetonatoplatinum(II), in order to initiate the addition reaction with the aid of light. These compounds may be encapsulated in a resin matrix.

The concentration of component (D) is sufficient for catalyzing the hydrosilylation reaction of components (A) and (B) and (C) on contact, in order to produce the heat required here in the process described. The amount of component (D) may be between 0.1 and 1000 parts per million (ppm), 0.5 and 100 ppm or 1 and 25 ppm of the platinum group metal, according to the total weight of the components. The curing rate may be low when the constituent of the platinum group metal is below 1 ppm. The use of more than 100 ppm of the platinum group metal is uneconomic or lowers the storage stability of the silicone composition.

The addition-crosslinking silicone compositions (S) may optionally contain all further additives that have also been used to date for production of addition-crosslinkable compositions. Examples of actively reinforcing fillers (E) not covered by the definition of the thermally conductive fillers (Z) that may be used as a component in the addition-crosslinking silicone compositions (Y) of the invention are fumed or precipitated silicas having BET surface areas of at least 50 m²/g, and carbon blacks and activated carbons such as furnace black and acetylene black, preference being given to fumed and precipitated silicas having BET surface areas of at least 50 m²/g.

The silica fillers (E) mentioned may have hydrophilic character or have been hydrophobized by known methods. Preferred fillers (E), as a result of the surface treatment, have a carbon content of at least 0.01% to a maximum of 20% by weight, preferably between 0.1% and 10% by weight, more preferably between 0.5% and 6% by weight.

In the addition-crosslinking silicone composition (S) of the invention, constituent (E) is preferably used in the form of a single finely divided filler or likewise preferably as a mixture of several thereof. The content of actively reinforcing filler in the crosslinkable silicone compositions (S) of the invention is in the range from 0% to 50% by weight, preferably 0% to 30% by weight, more preferably 0% to 10% by weight.

The crosslinkable addition-crosslinking silicone compositions (S) are more preferably characterized in that the filler (E) has been surface-treated. The surface treatment is achieved by the methods known in the prior art for hydrophobization of finely divided fillers €.

The addition-crosslinking silicone composition (S) of the invention may contain alkyltrialkoxysilanes (F) as further additions in order to reduce the viscosity thereof. If they are present, they are preferably present to an extent of 0.1-8% by weight, preferably 0.2-6% by weight, based on the total mass of silicone composition (S), where the alkyl group may be a saturated or unsaturated, linear or branched alkyl group having 2 to 20, preferably 8-18, carbon atoms, and the alkoxy groups may have 1 to 5 carbon atoms. Examples of the alkoxy groups include methoxy groups, ethoxy groups, propoxy groups and butoxy groups, particular preference being given to methoxy groups and ethoxy groups. Preferred for (F) is n-octyltri-methoxysilane, n-decyltrimethoxysilane, n-dodecyltrimethoxy-silane, n-hexadecyltrimethoxysilane and n-octadecyltrimethoxy-silane.

The addition-crosslinking silicone composition (S) of the invention may optionally contain, as constituents, further additions in a proportion of up to 70% by weight, preferably up to 42% by weight, based in each case on the addition-crosslinking silicone composition (S) of the invention, these being different from the thermally conductive fillers (Z) of the invention and the additions (E) and (F). These additions may, for example, be inactive fillers, resinous polyorganosiloxanes other than the siloxanes (A), (B) and (C), non-reinforcing fillers, fungicides, fragrances, rheological additives, corrosion inhibitors, oxidation inhibitors, light stabilizers, retardants and compositions for influencing electrical properties, dispersing aids, solvents, adhesion promoters, pigments, dyes, plasticizers, organic polymers, heat stabilizers etc.

### Thermally Conductive Filler (Z)

The crosslinkable heat-conducting silicone composition (Y) of the invention contains at least one thermally conductive filler (Z) having a thermal conductivity of at least 5 W/mK, with the proviso that the crosslinkable heat-conducting silicone compositions (Y) contain at least 20% by volume of metallic light metal alloy particles as thermally conductive fillers (Z) that still have to fulfill at least the further specific features a) to c), and the total amount of thermally conductive fillers (Z) is at least 40% by volume.
a) The median diameter x50 of these metallic light metal alloy particles (Z) of the invention is in the range of 25-150 μm, preferably in the range of 30-140 μm, more preferably in the range of 40-130 μm, particularly preferably in the range of 50-125 μm.
b) The metallic light metal alloy particles (Z) of the invention are produced in the last production step via a melting process and hence have a predominantly rounded surface shape.
c) The distribution range of the particle size (SPAN) is defined as SPAN=(x90−x10)/x50. The SPAN of the metallic light metal alloy particles (Z) of the invention is at least 0.4, preferably at least 0.5, more preferably at least 0.6, especially preferably at least 0.7. In a preferred embodiment, the SPAN is between 0.7 and 2.5, especially between 0.75 and 2.

It is immaterial here whether a single fraction of light metal alloy particles (Z) having a SPAN within the range of the invention is used, or whether two or more fractions of light metal alloy particles are mixed and hence the inventive particle size distribution range according to feature c) of the inventive light metal alloy particles (Z) is achieved. If two or more fractions of light metal alloy particles are mixed, this may precede the mixing with one or more components of the composition of the invention, or the fractions of light metal alloy particles may also be mixed separately from one another with one or more components of the composition of the invention. The sequence of addition here does not matter.

Preferably not more than four fractions of light metal alloy particles are mixed so as to achieve the distribution range of the invention, preferably not more than three fractions of light metal alloy particles are mixed so as to achieve the distribution range of the invention, more preferably not more than two fractions of light metal alloy particles of the invention are used so as to achieve the distribution range of the invention, and especially preferably just a single light metal alloy particle of the invention is used.

Metallic light metal alloys have multiple very advantageous properties for use as a thermally conductive filler (Z). For example, the exceptionally high thermal conductivity of light metal alloy particles such as, for example, based on aluminum, silicon or magnesium (Z) improves the thermal conductivity of the thermally conductive silicone composition (Y) produced therefrom. The low density of the light metal alloy particles (Z) reduces the weight of the composition and of the components produced therefrom and helps to save costs. Further properties, such as electrical conductivity, Mohs hardness and brittleness, can be controlled and optimized in a targeted manner within a wide range as required by the application via the combination of different alloy metals and the ratio of components of the alloy, and hence, for example, electrically dissipative or electrically insulating silicone compositions can be produced, or, for example, the abrasiveness of the particles can be reduced.

The light metal alloy of the invention contains, as the main constituent, at least 60% by weight, preferably at least 70% by weight, more preferably at least 80% by weight, especially at least 90% by weight, of a light metal or of a light semimetal selected from B, C, S, P, Be, Mg, Ca, Al and Si.

Preferred light metal alloys contain, as main constituents, at least 60% by weight, preferably at least 70% by weight, more preferably at least 80% by weight, especially at least 90% by weight, of a light metal or of a light semimetal selected from Al, Ca, Mg and Si, where Al and Si are especially preferred as main constituents.

In a particularly preferred embodiment, the light metal alloys are essentially free of heavy metals.

It is known to the person skilled in the art that metallic light metal alloy particles are combustible under particular conditions and the dusts present an explosion risk. The person skilled in the art is also aware that the risk of dust formation, combustibility and explosion risk associated with metal powders increases significantly with decreasing particle size. For that reason, very small light metal alloy particles below 25 μm are unsuitable for many applications, for example as filler for gap fillers in lithium ion batteries. Such particles, on account of the low minimum ignition energy, are hazardous to handle and require complex and costly safety precautions in industrial processing. It has also been found that compositions containing very small light metal alloy particles below 25 μm are comparatively highly combustible and do not meet the UL94 V-0 combustibility class for gap fillers in lithium ion batteries.

The light metal alloy particles of the invention contain preferably less than 20% by weight, more preferably less than 15% by weight, especially preferably less than 10% by weight, of a particle fraction having a diameter of not more than 20 μm, based in each case on the total amount of light metal alloy particles.

The light metal alloy particles of the invention contain preferably less than 15% by weight, more preferably less than 10% by weight, especially preferably less than 5% by weight, of a particle fraction having a diameter of not more than 10 μm, based in each case on the total amount of light metal alloy particles.

In an especially preferred embodiment, there is no intentional addition of light metal alloy particles having an average diameter of not more than 20 μm, more preferably of not more than 10 μm, especially of light metal alloy particles no larger than 5 μm.

Larger light metal alloy particles having an average particle size exceeding 25 μm have a comparatively high minimum ignition energy and are therefore more safely and easily processible in industrial processes. Nevertheless, compositions which contained noninventive ground, angular light metal alloy particles larger than 25 μm were found to be comparatively highly combustible and did not meet the UL94 V-0 combustibility class for gap fillers in lithium ion batteries.

Light metal alloy particles having an average particle size exceeding 150 μm are unsuitable for many applications of heat-conducting silicone composition since such large-grain light metal alloy particles frequently do not fit into the fine gaps that have to be filled with gap fillers, for example. Moreover, it is found that, very unexpectedly, even such large-grain light metal alloy particles show comparatively high combustibility.

It has been found that, completely surprisingly, the crosslinkable silicone compositions (Y) of the invention are thermally conductive and simultaneously of low combustibility when they contain metallic light metal alloy particles of the invention that simultaneously fulfill features a) to c), in the required minimum amounts.

The crosslinkable silicone composition (Y) of the invention contains at least 20% by volume of such metallic light metal alloy particles (Z), preferably at least 25% by volume, more preferably at least 30% by volume, especially preferably at least 35% by volume. If the silicone composition (Y) contains smaller amounts of metallic light metal alloy particles (Z), the desired advantageous effects of the metallic light metal alloy particle, for example the low density and high thermal conductivity, are no longer sufficiently provided.

The prior art includes various methods of producing fine metallic particles. The light metal alloy particles (Z) of the invention are produced from a molten state, as a result of which they have a comparatively smooth surface and are essentially free of fractures, sharp edges and pointed corners. In this way, they differ from conventional ground particles that have been converted to the final form, for example, by means of crushing, grinding or milling. It is immaterial here whether the particles are comminuted cold in a first process step, for example by grinding, and then converted to a molten form by heating above the melting point, for example by heat treatment in a hot zone, for example by means of a plasma, or whether a melt is first produced and then comminuted, for example by atomizing. The light metal alloy particles of the invention are preferably converted to the solid form of the invention by spraying or atomizing of a light metal alloy melt, followed by cooling.

Suitable methods of producing the light metal alloy particles (Z) of the invention are known to the person skilled in the art and are described, for example, in chapter 2.2 in “Pulvermetallurgie: Technologien und Werkstoffe [Powder Metallurgy: Technologies and Materials], Schatt, Werner, Wieters, Klaus-Peter, Kieback, Bernd, pp. 5-48, ISBN 978-3-540-681112-0, E-Book: https://doi.org/10.1007/978-3-540-68112-0_2”. Preferred processes for producing light metal alloy particles (Z) of the invention are inert gas atomization, also called gas atomization, pressurized water atomization, also called liquid atomization or water atomization methods, or melt spinning methods, also called centrifugal atomization or rotary atomization.

The processes described permit the production of metallic light metal alloy particles in a very different particle size range, especially in the average particle size range from a few micrometers to a few millimeters. It is also possible for the metallic light metal alloy particles to be produced in very different grain form, for example “spattered”, i.e. in very irregular, nodular, ellipsoidal or spherical form, and with a very variable range of particle size distribution. Irrespective of grain shape, these particles produced by means of a melting process have a comparatively smooth surface of the invention and are essentially free of fracture sites, sharp edges and pointed corners.

Completely surprisingly, it has been found that advantageous properties of the invention, especially comparatively low combustibility, are exhibited exclusively by those light metal alloy particles that are produced by a melting process, and hence have a predominantly rounded surface shape, and simultaneously fulfill the inventive features a) to c).

The production process for the metallic light metal alloy particles (Z) of the invention should preferably be executed in such a way that the particles are obtained in their predominantly rounded surface shape of the invention and hence fulfill features a)-c) and are essentially free of angular or sharp particles. The solidified particles may be separated by size in a subsequent process step by standard methods, for example by means of classifying by sieving or by means of sifting. In these methods, it is possible to separate agglomerates and bonded particles, but essentially no particles are destroyed. What is meant by “predominantly rounded” and “essentially free of” is that the presence of such particles is tolerated within the scope of an impurity in the particles (Z) of the invention and does not disrupt their inventive effect.

The crosslinkable silicone composition (Y) of the invention may, as well as these metallic light metal alloy particles (Z), contain further thermally conductive fillers (Z) having thermal conductivity greater than 5 W/mK. Examples of such further thermally conductive fillers (Z) are magnesium oxide, metallic aluminum powder, metallic silicon powder, metallic silver powder, zinc oxide, boron nitride, aluminum carbide, aluminum nitride, aluminum hydroxide, aluminum oxide, graphite, and so forth. Preferred further fillers are aluminum powder, magnesium oxide, aluminum hydroxide, zinc oxide and aluminum oxide. Particularly preferred fillers are zinc oxide, aluminum hydroxide and aluminum oxide, with aluminum hydroxide being especially preferred. The shape of the further filler is fundamentally unrestricted. The particles may, for example, be of spherical, ellipsoidal, acicular, tubular, platelet, fibrous or irregular shape. They are preferably of spherical, ellipsoidal or irregular shape. The average diameter of the further thermally conductive fillers (Z) is preferably in the range of 0.01-150 μm, preferably in the range of 0.1-100 μm, more preferably in the range of 0.2-80 μm, especially in the range of 0.4-60 μm.

Fillers having very high density are disadvantageous in use in aircraft and electrical vehicles, for example, since they very significantly increase the weight of the components. The further thermally conductive fillers (Z) preferably have a density of not more than 5.0 kg/m³, preferably not more than 3.8 kg/m³, more preferably not more than 3.0 kg/m³.

The crosslinkable silicone composition (Y) of the invention preferably contains less than 16% by weight, preferably less than 14% by weight, more preferably less than 12% by weight, of a further heat-conducting filler (Z) having a density of greater than 5.0 kg/m³. In an especially preferred embodiment, the crosslinkable silicone composition (Y) of the invention is free of further heat-conducting fillers (Z) having a density of greater than 5.0 kg/m³.

The crosslinkable silicone composition (Y) of the invention preferably contains less than 35% by weight, preferably less than 30% by weight, more preferably less than 25% by weight, especially preferably less than 20% by weight, of a further heat-conducting filler (Z) having a density of greater than 3.0 kg/m³. In an especially preferred embodiment, the crosslinkable silicone composition (Y) of the invention is free of further heat-conducting fillers (Z) having a density of greater than 3.0 kg/m³.

Preferred crosslinkable silicone compositions (Y) of the invention contain, as thermally conductive filler (Z), metallic light metal alloy particles of the invention as the sole thermally conductive filler (Z) or in combination with up to two further thermally conductive fillers (Z). Impurities of up to 5% are not considered here to be a further filler (Z).

If the preferred compositions of the invention contain the metallic light metal alloy particles (Z) of the invention as the sole thermally conductive filler (Z) having a thermal conductivity greater than 5 W/mK, preference is given to adding a rheology modifier or thickener that prevents the settling of the filler. Suitable rheology modifiers are known to the person skilled in the art, preference being given to fumed silica, for example component (E).

The total amount of thermally conductive fillers (Z) in the crosslinkable heat-conducting silicone composition (Y) of the invention is 40-95% by volume, preferably 50-90% by volume, more preferably 60-88% by volume. If the silicone composition (Y) contains smaller amounts of heat-conducting filler (Z), thermal conductivity will be inadequate; if the silicone composition (Y) contains greater amounts of heat-conducting filler (Z), then the composition (Y) will be difficult to process since it will have high viscosity or even be brittle.

The uncrosslinked heat-conducting silicone compositions (Y) of the invention have a thermal conductivity of at least 0.6 W/mK, preferably at least 0.8 W/mK, more preferably at least 1.2 W/mK, especially at least 1.5 W/mK.

The viscosity of the uncrosslinked thermally conductive silicone compositions (Y) of the invention may vary within a very wide range and be matched to the requirements of the application. The viscosity of the uncrosslinked thermally conductive silicone compositions (Y) of the invention is preferably adjusted via the content of thermally conductive filler (Z) and/or the composition of the silicone composition (Z), by the standard methods from the art. These are known to the person skilled in the art. Preference is given to adjusting the viscosity via the selection and combination of components (A), (B) and (C) and optional addition of a rheology modifier and/or an active filler (E) and/or an alkyltrialkoxysilane (F).

The dynamic viscosity of the uncrosslinked, thermally conductive silicone compositions (Y) of the invention is preferably in the range of 100-1 000 000 mPa·s, preferably in the range of 1000-750 000 mPa·s, more preferably in the range of 2000-500 000 mPa·s, especially not more than 250 000 mPa·s, in each case at shear rate D=10 s⁻¹ and 25° C.

The density of the uncrosslinked silicone compositions (Y) of the invention is less than 3.5 kg/m³, preferably less than 3.0 kg/m³, more preferably less than 2.6 kg/m³, especially less than 2.3 kg/m³.

The present invention further provides a process for producing the crosslinkable silicone compositions (Y) of the invention by mixing the individual components.

The components may be mixed by the customary continuous and batchwise prior art methods. Suitable mixing apparatus is any of the known apparatuses. Examples of these are uniaxial or biaxial continuous mixers, twin rollers, Ross mixers, Hobart mixers, dental mixers, planetary mixers, kneaders and Henschel mixers or similar mixers. Preference is given to mixing in a planetary mixer, a kneader or a continuous mixer. The crosslinkable silicone composition (Y) may optionally be heated in the course of mixing, preference being given to mixing within a temperature range of 15-40° C. The procedure for production of the preferred addition-crosslinkable silicone compositions (S) is also known to the person skilled in the art. In principle, the components may be added in any sequence. For example, components e) and optionally g) may be premixed and then mixed with components a) and/or b). It is optionally also possible here to heat and/or evacuate the mixture. Preference is given to mixing at least a portion of a) and the alkoxysilane g), then mixing in the heat-conducting filler(s) (Z). The production preferably takes place without active heating.

In a preferred embodiment, there is no intentional addition of light metal alloy particles having an average diameter of not less than 20 μm, more preferably of not less than 10 μm, especially of light metal alloy particles no larger than 5 μm, since this is associated with a particular safety risk in industrial production.

The crosslinkable silicone composition (Y) of the invention may be provided as a one-, two- or multicomponent mixture. Examples are two-component heat-curable compositions (Y) or one-component UV-crosslinkable compositions (Y). This has likewise long been known to the person skilled in the art.

The crosslinkable silicone composition (Y) of the invention has very good processing properties with regard to fluidity, gap-filling properties and layer thickness control, and can be applied precisely.

The temperature condition for the curing of the silicone composition (Y) which is preferably curable via hydrosilylation reaction is unlimited and is typically in the range from 20 to 180° C., preferably in the range from 20 to 150° C., preferably in the range from 20 to 80° C.

The present invention further provides the silicone products obtained by dispensing or applying and then crosslinking/curing the crosslinkable silicone composition. The cured silicone products (for example a heat-conducting element) show excellent thermal conductivity and exact layer thicknesses.

The hardness of the crosslinked thermally conductive silicone compositions (Y) of the invention may vary within a very wide range and be matched to the requirements of the application. For example, for the application as a gap filler, preference is given to using comparatively soft and flexible products, whereas, for example, for the application as a thermally conductive adhesive, preference is given to using comparatively hard and firm products. The hardness of the crosslinked thermally conductive silicone compositions (Y) of the invention is preferably adjusted via the composition of the silicone composition (S), by the standard methods from the prior art. These are known to the person skilled in the art. Preference is given to adjusting the hardness via the selection and combination of components (A), (B) and (C) and optional addition of a reinforcing filler (E).

The hardness of the cured silicone product is preferably in the range from 2 by the Shore 00 method to 100 by the Shore A method, preferably in the range from 10 by the Shore 00 method to 85 by the Shore A method. For the application as a gap filler, the hardness of the crosslinked thermally conductive silicone compositions of the invention is especially preferably in the range from 15 by the Shore 00 method to 65 by the Shore A method.

The crosslinked silicone products have a thermal conductivity of at least 0.6 W/mK, preferably at least 0.8 W/mK, more preferably at least 1.2 W/mK, especially at least 1.5 W/mK.

The present invention further provides for the use of the crosslinkable silicone composition as a gap filler (=heat-conducting element), heat-conducting pad, heat-conducting adhesives and encapsulating compounds. They are especially suitable for use as a gap filler for lithium ion batteries of electrical vehicles and as encapsulating compounds for electronic components, for example of electrical vehicles.

The density of the crosslinked silicone products of the invention is less than 3.5 kg/m³, preferably less than 3.0 kg/m³, more preferably less than 2.6 kg/m³, especially less than 2.3 kg/m³.

The crosslinked silicone products of the invention preferably conform to the UL94 V-0 combustibility class.

In a preferred embodiment, the density of the crosslinked silicone products of the invention is less than 2.5 kg/m³, and the thermal conductivity greater than 1.8 W/mK, and the combustibility satisfies UL94 V-0, with the proviso that the dynamic viscosity of the uncrosslinked silicone compositions of the invention is less than 500 000 mPa·s, especially less than 250 000, in each case at shear rate D=10 s⁻¹ and 25° C.

In a particularly preferred embodiment, the density of the silicone products of the invention is less than 2.3 kg/m³, and the thermal conductivity greater than 1.8 W/mK, preferably greater than 3.0 W/mK, and the combustibility satisfies UL94 V-0, with the proviso that the dynamic viscosity of the uncrosslinked silicone compositions of the invention is less than 500 000 mPa·s, especially less than 250 000, in each case at shear rate D=10 s⁻¹ and 25° C.

### Test Methods

### Measurement of Thermal Conductivity Lambda

Thermal conductivity is determined to ASTM D5470-12 using a TIM Tester (Steinbeis Transferzentrum Warmemanagement in der Elektronik, Lindenstr. 13/1, 72141 Walddorfhaslach, Germany). This determines the thermal resistance of the sample between 2 test cylinders by means of a constant heat flow. The layer thickness of the sample is used to calculate the effective thermal conductivity.

For the measurement, the sample is is applied with the aid of a stencil and the measuring cylinder is narrowed manually to a thickness of 1.9-2.0 mm, then excess material is remove. Thermal conductivity is measured at a constant gap of 1.8-1.6-1.4-1.2-1.0 mm. Evaluation is effected by means of an integrated reporter position. After a plausibility test (straight-line coefficient of determination >0.998), the thermal conductivity lambda is reported as the effective thermal conductivity in W/(m*K).

### Measurement of Dynamic Viscosity

Dynamic viscosity was measured using an Anton Paar MCR 302 rheometer according to DIN EN ISO 3219: 1994 and DIN 53019 by means of a flow curve with the following parameters: measurement type: T/D; temperature: 25.0° C.; measuring element: PP25; measurement gap: 0.50 mm; shear rate: 0.1-10 s⁻¹; time: 120 sec; measurements: 30. The viscosity reported in Pa·s is an interpolated value at a shear rate of D=10 s⁻¹.

### Measurement of Density

The density of the uncrosslinked, thermally conductive silicone compositions was ascertained according to ISO 1183, and the density of the crosslinked thermally conductive silicone compositions according to ISO 1184.

### Particle Size and Particle Shape Analysis

Particle size (median diameter x50) and particle size distribution (parameter: distribution range SPAN) were analyzed with a Camsizer X2 from Retsch Technology (measurement principle: dynamic image analysis) according to ISO 13322-2 and ISO 9276-6 (method of analysis: dry measurement of powders and granules; measurement range: 0.8 μm-30 mm; compressed air dispersion with “X-Jet”; dispersion pressure=0.3 bar). Evaluations were volume-based and by the x_{c min} model.

The examples which follow describe the basic implementability of the present invention, but without limiting it to the contents disclosed therein.

In the examples which follow, all figures for parts and percentages, unless stated otherwise, are based on weight. Unless stated otherwise, the examples which follow are conducted at a pressure of the surrounding atmosphere, i.e. at about 1000 hPa, and at room temperature, i.e. about 20° C. or a temperature which is established on combination of the reactants at room temperature without additional heating or cooling.

### EXAMPLES

### Overview of the Inventive and Noninventive Alloy Particles and Light Metal Alloy Particle Mixtures Used

The light metal alloys listed in table 1 are used in the inventive and noninventive examples.

TABLE 1

| | | Alloy | | | | |
|---|---|---|---|---|---|---|
| | | A | B | C | D | E |
| Al | (% by weight) | 88 | 2.5 | 95 | 77.9 | 88 |
| Mg | (% by weight) | | | | 0.6 | |
| Si | (% by weight) | 12 | 90 | | 17 | 8.5 |
| Fe | (% by weight) | | 7.5 | | | |
| Ti | (% by weight) | | | 5 | | |
| Cu | (% by weight) | | | | 4.5 | 3.5 |
| Density | (g/ml) | 2.65 | 2.47 | 2.76 | 2.70 | 2.73 |

Table 2 shows the properties of the inventive (examples 1 to 7) and noninventive (comparative examples V1 to V8) light metal alloy particles used in the crosslinkable, heat-conducting silicone compositions.

Inventive examples 1-6 use inventive light metal alloy particles that have been obtained by means of inert gas atomization, and hence are predominantly rounded, and additionally have a comparatively broad particle size distribution of the invention and thus fulfill all of features a) to c) of the invention.

Noninventive comparative examples V1-V4 use noninventive light metal alloy particles that have been obtained by means of inert gas atomization, and hence are predominantly rounded, but have a comparatively narrow, noninventive particle size distribution and do not fulfill feature c) of the invention.

Noninventive comparative examples V5-V7 use noninventive light metal alloy particles that have a comparatively broad particle size distribution, but have been obtained by means of grinding methods, and hence are essentially angular and sharp-edged and do not fulfill feature b) of the invention.

### Example 7: Production of the Light Metal Alloy Particle Mixture 7 (Inventive)

100 g of the noninventive light metal alloy particle from comparative example V2, 200 g of the noninventive light metal alloy particle from comparative example V3, 400 g of a noninventive light metal alloy particle of alloy A which has an x50 of 103.5 μm and a SPAN of 0.31 and has been produced by means of inert gas atomization and hence is essentially rounded, 200 g of a noninventive light metal alloy particle of alloy A which has an x50 of 134.2 μm and a SPAN of 0.24 and has been produced by means of inert gas atomization and hence is essentially rounded, and 100 g of the noninventive light metal alloy particle from comparative example V4 are mixed homogeneously with a standard commercial RW 28 laboratory stirrer system (IKA®-Werke GmbH & CO. KG, 79219 Staufen, Germany). This gives an inventive light metal alloy particle mixture which has an x50 of 106.9 m and a SPAN of 0.77 and is essentially rounded, and fulfills features a) to c) of the invention.

### Comparative Example V8: Production of Light Metal Alloy Particle Mixture V8 (Noninventive)

300 g of a noninventive light metal alloy particle of alloy A which has an x50 of 134.2 μm and a SPAN of 0.24 and has been produced by means of inert gas atomization and hence is essentially rounded, and 600 g of the noninventive light metal alloy particle from comparative example V4 are mixed homogeneously with a standard commercial RW 28 laboratory stirrer system (IKA®-Werke GmbH & CO. KG, 79219 Staufen, Germany). This affords a noninventive light metal alloy particle mixture which has an x50 of 153.1 m and a SPAN of 0.42 and is essentially rounded, and does not fulfill feature a) of the invention.

### Abbreviations

Ex. example
V comparative example
PS particle shape
r predominantly rounded surface shape
e angular
I inventive
NI noninventive
n.d. not determined

TABLE 2
Overview of the properties of the light metal alloy particles

| | | | ×50 | | | | |
|---|---|---|---|---|---|---|---|
| | | | (mm) | ×90 | SPAN | PS | |
| Ex. | Alloy | ×10 (mm) | Feature a) | (mm) | Feature c) | Feature b) | Comment |
| 1 | A | 15.3 | 32.1 | 44.8 | 0.92 | r | I |
| 2 | A | 17.6 | 37.4 | 56.8 | 1.05 | r | I |
| 3 | A | 22.4 | 50.4 | 69.7 | 0.94 | r | I |
| 4A | A | 28.7 | 66.1 | 96.8 | 1.03 | r | I |
| 4B | B | 28.3 | 66.5 | 97.9 | 1.05 | r | I |
| 4C | C | 27.8 | 67.6 | 95.6 | 1.00 | r | I |
| 4D | D | 26.5 | 67.8 | 94.2 | 1.00 | l | I |
| 4E | E | 30.4 | 66.2 | 93.5 | 0.95 | r | I |
| 5 | A | 54.5 | 83.1 | 126.5 | 0.87 | r | I |
| 6 | A | 99.3 | 137.4 | 170.4 | 0.52 | r | I |
| 7 | A | 73.5 | 108.3 | 153.6 | 0.74 | r | I |
| V1 | A | 44.2 | 53.6 | 63.2 | 0.35 | r | NI |
| V2 | A | 60.2 | 67.4 | 75.8 | 0.23 | r | NI |
| V3 | A | 71.5 | 81.6 | 93.4 | 0.27 | r | NI |
| V4 | A | 143.8 | 161.7 | 182.4 | 0.24 | r | NI |
| V5 | A | 11.1 | 36.5 | 85.9 | 2.05 | e | NI |
| V6 | A | 19.8 | 96.5 | 188.6 | 1.75 | e | NI |
| V7 | A | 3.2 | 6.2 | 9.1 | 0.95 | e | NI |
| V8 | A | 111.2 | 153.1 | 5 | 0.42 | r | NI |

### General Method 1 (GM1) for Production of the Crosslinked, Thermally Conductive, Light Metal Alloy Particle-Containing Shaped Silicone Bodies (Inventive Examples 8 to 14 and Noninventive Examples V9 to V20)

### Step 1: Preparation of an Addition-Crosslinkable, Thermally Conductive, Light Metal Alloy Particle-Containing Silicone Composition

24.5 g of a vinyldimethylsiloxy-terminated polydimethylsiloxane with a viscosity of 1000 mPa·s, 16.3 g of a hydrodimethylsiloxy-terminated polydimethylsiloxane with a viscosity of 1000 mPa·s, 1.0 g of a copolymer composed of dimethylsiloxy and methylhydrosiloxy and trimethylsiloxy units and having a viscosity of 200 mPa·s and a content of Si-bonded hydrogen of 0.18% by weight,
were homogenized by means of a SpeedMixer DAC 400 FVZ (Hauschild & Co KG, Waterkamp 1, 59075 Hamm, Germany) at a speed of 2350 rpm for 25 seconds. Thereafter, the light metal alloy particles were added in each case in the ratio according to table 3 and mixed by means of a SpeedMixer at 2350 rpm for 25 seconds. The light metal alloy-containing silicone composition was stirred with a spatula to mix in light metal alloy particle residues from the edge of the vessel. This was followed by homogenization at 2350 rpm by SpeedMixer for a further 25 seconds and cooling to room temperature.

For the crosslinking, 4.18 g of ELASTOSIL® CAT PT (purchasable from Wacker Chemie AG, Hanns-Seidel-Platz 4, 81737 Munich, Germany) was added, corresponding to a mixing ratio of 1 part catalyst solution to 10 parts silicone composition, not counting the proportion of thermally conductive filler (Z). The mixture was mixed three times at 2350 rpm by SpeedMixer for 10 seconds, stirring the sample each time by spatula between the mixing operations. What was obtained was a reactive, pasty mass which is storable for only a few hours and was processed further directly.

### Step 2: Production of a Crosslinked, Thermally Conductive, Light Metal Alloy Particle-Containing Shaped Silicone Body

A shaped body having dimensions of 207 mm×207 mm×2 mm was produced by means of compression vulcanization in a stainless steel mold at 165° C. and 380 N/cm² for 5 minutes by the standard prior art methods. The vulcanizate was then subjected to heat treatment at 200° C. for 4 hours. What was obtained was a homogeneous and elastic shaped body.

### Example 15 Combustibility Testing

Combustibility was tested in a simplified test based on UL 94 V, a standard from Underwriters Laboratories for testing of vertical burning that enables the classification of plastics by their flame retardancy. This method is the most common test for classification of flame-retardant plastics.

Test pieces each of length 5″ (127 mm) and width 0.5″ (12.7 mm) were punched out of the inventive shaped silicone bodies according to examples 8 to 14 and the noninventive shaped silicone bodies according to comparative examples V9 to V13 and V18 to V20. The plaque is secured in a vertical position at its upper end over a length of ¼″. 12″ (305 mm) beneath the test plaque is positioned a piece of cotton wool. The burner is adjusted such that a blue flame of length ¾″ is formed. The flame is directed from a distance of ⅜″ (9.5 mm) onto the lower edge of the plastic plaque. After contact for 10 seconds, the flame is removed. The afterflame time (total afterflame and afterglow time) for the test piece is noted. The sample should be extinguished immediately after the removal of the flame and burn for no more than a further 4 seconds. The test is conducted on 5 different test pieces, and the average value of the afterflame time is ascertained. The results can be found in table 3.

In noninventive comparative experiments V14 to V16, respectively containing 62.5% by volume of the noninventive light metal alloy particles according to comparative examples V5 to V7, which more particularly do not fulfill feature b), a silicone composition of very high viscosity was formed, which could not be pressed to give a suitable shaped silicone body.

TABLE 3
Light metal alloy particle-containing silicone compositions, properties
thereof and properties of the shaped bodies produced therefrom

| | Light metal alloy particles | | | | | | | |
|---|---|---|---|---|---|---|---|---|
| | used | | | | | | | |
| | Ex. | | | Crosslinkable silicone | | Shaped silicone body | | |
| | according | | | composition | | | | After- |
| | to | Amount | Content | Viscosity | Density | | Thermal | flame time |
| Ex. | Table 2 | (g) | (Vol.-%) | (Pa · s) | (kg/m³) | Hardness | conductivity | (s) |
| 8 | 1 | 171.6 | 62.5 | 6.4 | 1.94 | 71 | 1.8 | 2 |
| 9 | 2 | 171.6 | 62.5 | 6.0 | 1.94 | 75 | 1.9 | 2 |
| 10 | 3 | 171.6 | 62.5 | 6.2 | 1.94 | 76 | 2.1 | 0 |
| 11A | 4A | 171.6 | 62.5 | 5.0 | 1.94 | 70 | 2.0 | 2 |
| 11B | 4B | 178.1 | 62.5 | 5.2 | 2.00 | 68 | 1.9 | 0 |
| 11C | 4C | 190.2 | 62.5 | 4.9 | 2.11 | 71 | 1.8 | 1 |
| 11D | 4D | 198.5 | 62.5 | 5.3 | 2.18 | 75 | 1.9 | 2 |
| 11E | 4E | 244.5 | 62.5 | 4.2 | 2.61 | 70 | 1.9 | 0 |
| 12 | 5 | 171.6 | 62.5 | 3.5 | 1.94 | 71 | 1.9 | 0 |
| 13 | 6 | 171.6 | 62.5 | 4.3 | 1.94 | 85 | 1.8 | 1 |
| 14 | 7 | 171.6 | 62.5 | 4.7 | 1.94 | 78 | 2.0 | 3 |
| V9 | V1 | 171.6 | 62.5 | 9.1 | 1.94 | 69 | 2.0 | 8 |
| V10 | V2 | 171.6 | 62.5 | 13.5 | 1.94 | 81 | 1.9 | 12 |
| V11 | V3 | 171.6 | 62.5 | 14.5 | 1.94 | 73 | 2.0 | 7 |
| V12 | V4 | 171.6 | 62.5 | 16.2 | 1.94 | 79 | 2.0 | 6 |
| V13 | V8 | 171.6 | 62.5 | 3.7 | 1.94 | 82 | 1.8 | 13 |
| V14 | V5 | 171.6 | 62.5 | n.d. | n.d. | n.d. | n.d. | n.d. |
| V15 | V6 | 171.6 | 62.5 | n.d. | n.d. | n.d. | n.d. | n.d |
| V16 | V7 | 171.6 | 62.5 | n.d. | n.d. | n.d. | n.d | n.d. |
| V17 | V5 | 100.1 | 49.2 | 14.2 | 1.73 | 6 | 1.2 | 24 |
| V18 | V6 | 100.1 | 49.2 | n.d | 1.73 | 17 | 1.1 | 22 |
| V19 | V7 | 100.1 | 49.2 | n.d. | 1.73 | 28 | 1.3 | 57 |

Comparative examples V9 to V13 and V17 to V19, containing a noninventive light metal alloy particle or mixture according to comparative examples V1-V8 which does not fulfill one or more of features a) to c), show comparatively high combustibility in the testing of combustibility. Especially noticeable was the combustibility of noninventive comparative sample V19, containing a light metal alloy particle having an average particle size of less than rim. The sample continued to burn after the flame had been removed until the shaped body was completely burnt.

Entirely unexpectedly, it was found that light metal alloy particles that simultaneously fulfill features a)-c) show the inventive advantage of reduced combustibility. In inventive example 14, moreover, it was found, completely surprisingly, that mixing of multiple noninventive light metal alloy particles can produce an inventive light metal alloy particle mixture having the advantageous properties according to the invention of low combustibility, provided that the resultant mixture fulfills features a) to c). By contrast, the noninventive light metal alloy particle mixture from comparative example V8 does not fulfill features a) to c) and also does not show the advantages according to the invention.

### Example 16 Full Combustibility Test According to UL 94 V

The inventive shaped silicone bodies from inventive examples 11A and 12 and the noninventive shaped silicone bodies from noninventive comparative examples V10, V11 and V18 were subjected to the full combustibility test according to UL 94 V and classified as V-0, V-1 or V-2. For many industrial applications, especially for use as a gap filler in electrical vehicles, a V-0 classification is required. The results can be found in table 4.

TABLE 4

| Ex. | UL 94 V classification | Comment |
|---|---|---|
| 11A | V-0 | I |
| 12 | V-0 | I |
| V10 | V-1 | NI |
| V11 | V-1 | NI |
| V18 | V-2 | NI |

### Example 17 Production of a Crosslinked, Thermally Conductive Shaped Silicone Body Containing an In Situ Mixture of Two Light Metal Alloy Particles (Inventive)

According to general method GM1, an inventive crosslinkable thermally conductive silicone composition was produced by separately having, as light metal alloy particles, 187.55 g of the inventive light metal alloy particle from example 1 (37.6% by volume based on the total amount of the thermally conductive silicone composition) and 183.95 g of a noninventive light metal alloy particle of alloy A which has an x50 of 104.9 μm and a SPAN of 0.36 and has been produced by means of inert gas atomization and hence is essentially rounded (36.8% by volume based on the total amount of the thermally conductive silicone composition) and mixing them in situ to form an inventive light metal alloy particle mixture.

What was obtained was an inventive reactive silicone composition having a content of inventive light metal alloy particles of 74.4% by volume and a dynamic viscosity of 61 500 mPa·s at shear rate D=10 s⁻¹ and 25° C. The thermal conductivity was 5.14 W/mK and the density 2.22 kg/m³. The mass of the invention has good processibility, high thermal conductivity and low density, and is of very good suitability for use as a gap filler. General method GM1 was used to produce an inventive crosslinked shaped silicone body. The afterflame time according to example 15 was 0.9 seconds. Example 16 resulted in a UL94 V-0 classification.

### Comparative Example V20 Production of a Crosslinked Shaped Silicone Body Containing an In Situ Mixture of Two Light Metal Alloy Particles (Noninventive)

A crosslinked shaped silicone body was produced according to inventive example 17, except using 19.0% by volume of the light metal alloy particle from example 1 and 18.6% by volume of a noninventive light metal alloy particle of alloy A which has an x50 of 105.8 μm and a SPAN of 0.35 and has been produced by means of inert gas atomization and hence is essentially rounded.

The noninventive shaped silicone body has a noninventive total content of thermally conductive filler (Z) of 37.6% by volume and has a thermal conductivity of 0.48 W/mK.

Example 16 resulted in a UL94 V-1 classification. The composition is unsuitable for use as a gap filler.

### Example 18 Two-Component Gap Filler (Inventive)

### Production of the A Component

In a commercial Labotop planetary mixer (PC Laborsystem GmbH, Maispracherstrasse 6, 4312 Magden, Switzerland), equipped with two bar stirrers and a stripper, 115.4 g of a vinyldimethylsiloxy-terminated polydimethylsiloxane having a viscosity of 120 mPa·s, and 1.1 g of WACKER® CATALYST EP (purchasable from Wacker Chemie AG, Hanns-Seidel-Platz 4, 81737 Munich, Germany) were mixed at room temperature and a stirrer speed of 300 rpm for 5 minutes. 308.5 g of BAK-5 spherical alumina (purchasable from Shanghai Bestry Performance Materials Co., Ltd. Room 209, Yunchuang Space, 325 Yunqiao Road, Pudong, Shanghai) was added and incorporated homogeneously at 300 rpm under slightly reduced pressure (950 mbar) for 10 minutes. Subsequently, a total of 658.29 g of an inventive light metal alloy particle of alloy A that has an x50 of 79.2 μm and a SPAN of 1.61 and has been produced by means of inert gas atomization and hence is essentially rounded was added in two portions (first portion: 438.86 g, second portion: 219.53 g), and each addition was followed by mixing under slightly reduced pressure (950 mbar) at 300 rpm for 10 minutes. The resultant pasty mass was homogenized at 300 rpm under slightly reduced pressure (950 mbar) for a further 10 minutes. An inventive A component having a content of inventive light metal alloy particles of 55.5% by volume and a total content of thermally conductive filler of 73.1% by volume was obtained. The pasty composition has a density of 2.43 kg/m³, a dynamic viscosity of 53 200 mPa·s at shear rate D=10 s- and 25° C. and a thermal conductivity of 3.4 W/mK and is thus of very good suitability for use as a gap filler.

### Production of the B Component

In a commercial Labotop planetary mixer (PC Laborsystem GmbH, Maispracherstrasse 6, 4312 Magden, Switzerland), equipped with two bar stirrers and a stripper, 106.5 g of a vinyldimethylsiloxy-terminated polydimethylsiloxane having a viscosity of 120 mPa·s, and 9.0 g of a copolymer composed of dimethylsiloxy and methylhydrosiloxy and trimethylsiloxy units and having a viscosity of 200 mPa·s and a content of Si-bonded hydrogen of 0.18% by weight were mixed at room temperature and a stirrer speed of 300 rpm for 5 minutes. 306.0 g of BAK-5 spherical alumina (purchasable from Shanghai Bestry Performance Materials Co., Ltd. Room 209, Yunchuang Space, 325 Yunqiao Road, Pudong, Shanghai) was added and incorporated homogeneously at 300 rpm under slightly reduced pressure (950 mbar) for 10 minutes. Subsequently, a total of 652.83 g of inventive light metal alloy particle of alloy A that has an x50 of 78.8 μm and a SPAN of 1.64 and has been produced by means of inert gas atomization and hence is essentially rounded was added in two portions (first portion: 435.22 g, second portion: 217.61 g), and each addition was followed by mixing under slightly reduced pressure (950 mbar) at 300 rpm for 10 minutes. The resultant pasty mass was homogenized at 300 rpm under slightly reduced pressure (950 mbar) for a further 10 minutes. An inventive B component having a content of inventive light metal alloy particles of 55.5% by volume and a total content of thermally conductive filler of 73.1% by volume was obtained. The pasty composition has a density of 2.43 kg/m³, a dynamic viscosity of 39 500 mPa·s at shear rate D=10 s⁻¹ and 25° C. and a thermal conductivity of 3.5 W/mK and is thus of very good suitability for use as a gap filler.

### Production of a Shaped Body

An inventive crosslinked specimen was produced by homogeneously mixing 1 part by weight of the inventive A component and 1 part by weight of the inventive B component, followed by vulcanization according to general method GM1. The resultant shaped body has a Shore A hardness of 1.8. Example 16 resulted in a UL94 V-0 classification. The composition is of very good suitability for use as a gap filler.

1-14. (canceled)

15. A crosslinkable, heat-conducting silicone composition (Y), comprising:
wherein 5-60% by volume of a crosslinkable silicone composition (S);
wherein 40-95% by volume of at least one thermally conductive filler (Z) having a thermal conductivity of at least 5 W/mK;
wherein the crosslinkable, heat-conducting silicone composition (Y) has a thermal conductivity of at least 0.6 W/mK;
wherein at least 20% by volume of metallic light metal alloy particles are present as thermally conductive fillers (Z) that fulfill the following features:
a) wherein their median diameter x50 is in the range of 25-150 μm,
b) wherein they are produced in the last production step by a melting process and have a predominantly rounded surface shape, and
c) wherein their distribution range SPAN ((x90−x10)/x50) is at least 0.40; and
wherein the metallic light metal alloy particles contain, as main constituent, at least 60% by weight of a light metal or of a light semimetal selected from B, C, S, P, Be, Mg, Ca, Al and Si.

16. The composition (Y) of claim 15, wherein the composition (Y) is an addition-crosslinking silicone composition.

17. The composition (Y) of claim 15, wherein the composition (Y) contains at least 25% by volume of metallic light metal alloy particles as thermally conductive fillers (Z).

18. The composition (Y) of claim 15, wherein the composition (Y) contains only one or two further thermally conductive fillers (Z) aside from the metallic light metal alloy particles.

19. The composition (Y) of claim 15, wherein less than 16% by weight of a further thermally conductive filler (Z) having a density of greater than 5.0 g/cm³ is present.

20. The composition (Y) of claim 15, wherein the median diameter x50 of the metallic light metal alloy particles is in the range of 40-130 μm.

21. The composition (Y) of claim 15, wherein the metallic light metal alloy particles contain less than 20% by weight of a particle fraction having a diameter of not more than 20 μm based on the total amount of light metal alloy particles.

22. The composition (Y) of claim 15, wherein the composition (Y) has a thermal conductivity of at least 0.8 W/mK.

23. The composition (Y) of claim 15, wherein the composition (Y) has a dynamic viscosity of 1000-750 000 mPa·s, in each case at shear rate D=10 s⁻¹ and 25° C.

24. The composition (Y) of claim 15, wherein the composition (Y) is dispensable or able to be applied.

25. The composition (Y) of claim 15, wherein the composition (Y) is used as a gap filler (heat-conducting element), heat-conducting pad, heat-conducting adhesives or as encapsulating compounds.

26. The composition (Y) of claim 15, wherein the composition (Y) is used as a gap filler for lithium-ion batteries of electrical vehicles.

27. The composition (Y) of claim 15, wherein the composition (Y) is used as an encapsulating compound in electrical vehicles.

28. A process for producing a crosslinkable, heat-conducting silicone composition (Y), comprising:
providing 5-60% by volume of a crosslinkable silicone composition (S);
providing 40-95% by volume of at least one thermally conductive filler (Z) having a thermal conductivity of at least 5 W/mK;
wherein the crosslinkable, heat-conducting silicone composition (Y) has a thermal conductivity of at least 0.6 W/mK;
wherein at least 20% by volume of metallic light metal alloy particles are present as thermally conductive fillers (Z) that fulfill the following features:
a) wherein their median diameter x50 is in the range of 25-150 μm,
b) wherein they are produced in the last production step by a melting process and have a predominantly rounded surface shape, and
c) wherein their distribution range SPAN ((x90−x10)/x50) is at least 0.40;
wherein the metallic light metal alloy particles contain, as main constituent, at least 60% by weight of a light metal or of a light semimetal selected from B, C, S, P, Be, Mg, Ca, Al and Si; and
mixing the individual components together

29. The process of claim 28, further comprising the step of dispensing or applying the heat-conducting silicone composition (Y) obtained.
